(19) United States
(12) Patent Application Publication
(10) Pub. No.: US 2015/0101460 A1
(43) Pub. Date: Apr. 16, 2015

(54) REVERSIBLE MONKEY WRENCH

(71) Applicant: PROXENE TOOLS CO., LTD., Taichung (TW)

(72) Inventor: Arthur WU, Taichung (TW)

(73) Assignee: PROXENE TOOLS CO., LTD., Taichung (TW)

(21) Appl. No.: 14/051,569

(22) Filed: Oct. 11, 2013

(51) Int. Cl. B25B 13/24; B25B 13/14

(52) U.S. Cl. CPC B25B 13/24; B25B 13/14
USPC 81/165

(57) ABSTRACT

A reversible monkey wrench is provided. An end of a head is formed with a fixed jaw, a sliding rail and a receiving slot. The movable jaw has a sliding rod slidably disposed in the sliding rail. The axial rod is disposed in the head and extended into the receiving slot. A worm gear has an engaging portion corresponding to the sliding rod and an axial bore for receiving the axial rod. The worm gear is slidably disposed in the receiving slot and an end thereof is formed with a first dragging portion. A dragging mechanism is disposed around the axial rod and circumferentially contacted with the first dragging portion, dragging portion and friction between the first dragging portion and the dragging mechanism can prevent simultaneous rotation of the worm gear.

### BACKGROUND OF THE INVENTION

1. Field of the Invention

The present invention relates to a monkey wrench, and more particularly to a reversible monkey wrench.

2. Description of the Prior Art

Monkey wrenches are one of the most common types of hand tools. Some of them are designed to be reversible, in which they can drive a nut in one direction and run idle in the reverse direction, so that they would not have to disengage from the nut after every turning stroke.

Some reversible monkey wrench is provided with a movable jaw that moves away from the fixed jaw when they are reversely turned, such as disclosed in U.S. Pat. No. 3,312,129, U.S. Pat. No. 5,746,099, and U.S. Pat. No. 6,679,139. These patents disclose a monkey wrench with a worm gear being slidable along with its axial rod.

However, in the conventional reversible monkey wrenches as shown in FIGS. 12 to 15, helical teeth 2 of a worm gear 1 is spiral (from a top view or a side view, the helical teeth 2 extend in the direction toward the fixed jaw and extend from upper left to lower right, like). When the reversible monkey wrench is turned in the opposite direction of screwing a fastener (a nut) tightly (which means to run idle), the fastener will apply a horizontal force F on the movable jaw 3 (as shown in FIG. 12). The horizontal force F is transmitted to the helical teeth 2 of the worm gear 1 through a sliding rod 4 of the movable jaw 3, and a worm gear return spring (the worm gear return spring 73 as shown in FIG. 2) will exert a counter force F′ which is equal and opposite to the horizontal force F (as shown in FIG. 14) onto the worm gear 1. The counter force F′ will urge the worm gear 1 to allow the helical teeth 2 to be abutted against the sliding rod 4 with a helix angle of the movable jaw 3, and the helical teeth 2 spirally extend toward the fixed jaw; therefore, force produced due to the worm gear 1 is abutted against the helical teeth 2 and the counter force F′ act against each other, and a oblique component force f′ of the counter force F′ parallel to the spiral direction will force the worm gear 1 to rotate downward, and the movable jaw 3 will move away from the fixed jaw. Consequently, after many times of turning the reversible monkey wrench, the gap between the movable jaw 3 and the fixed jaw will be gradually larger, so the reversible monkey wrench can't fixedly clamp the fastener and drive the fastener to rotate, and corner verges of the fastener are easier to be blunted and damaged.

The present invention is, therefore, arisen to obviate or at least mitigate the above-mentioned disadvantages.

### SUMMARY OF THE INVENTION

The main object of the present invention is to provide a reversible monkey wrench which can prevent the opening width from becoming larger when being turned reversely. In addition, the reversible monkey wrench has a simple structure, and it is easy to assemble and cheap to manufacture the reversible monkey wrench.

To achieve the above and other objects, the present invention provides a reversible monkey wrench, including a handle, a head, a movable jaw, an axial rod, a worm gear and a dragging mechanism. An end of the head is formed with a fixed jaw, a sliding rail and a receiving slot. The movable jaw has a sliding rod, and the sliding rod is slidably disposed in the sliding rail of the head. The axial rod is disposed in the head and extended into the receiving slot. The worm gear has an engaging portion corresponding to the sliding rail and an axial bore for the axial rod to dispose therethrough. The worm gear is slidably disposed in the receiving slot and slidable along the axial rod. An end of the worm gear is formed with a first dragging portion. The dragging mechanism is disposed around the axial rod and circumferentially contacted with the first dragging portion, wherein when the worm gear is axially slid, the dragging mechanism and the first dragging portion are contacted with each other, and friction caused by the contact of the first dragging portion with the dragging mechanism is larger than an oblique component force opposite to the friction, so the worm gear is unrotatable around the axial rod. The oblique component force is defined as a component force parallel to a spiral direction of the engaging portion.

To achieve the above and other objects, the present invention further provides a reversible monkey wrench, including a handle, a head, a movable jaw, an axial rod, a worm gear and a dragging mechanism. The handle has a connecting end. An end of the head is formed with a fixed jaw, a sliding rail, a receiving slot and a connecting bore. The receiving slot is communicated with the sliding rail. A bottom end of the head and the connecting end are swingably connected through a pivot. A handle return spring, a movable pin and a movable pin return spring are disposed between the head and the connecting end. The pivot is positioned between the handle return spring and the movable pin, and the handle return spring is abutted against the head and the connecting end. The movable pin is disposed through the connecting bore, and the movable pin return spring is abutted between the head and the movable pin and urges the movable pin toward the connecting end. The movable pin has a sliding rod, and the sliding rod is slidably disposed in the sliding rail of the head. The axial rod is disposed in the head and extended into the receiving slot. The worm gear has an engaging portion corresponding to the sliding rod and an axial bore for the axial rod to dispose therethrough. The engaging portion spirally extends toward the fixed jaw. The worm gear is slidably disposed in the receiving slot and slidable along the axial rod. An end of the worm gear is formed with a first dragging portion. The dragging mechanism is disposed around the axial rod and circumferentially engaged or contacted with the first dragging portion, wherein when the worm gear is axially slid, the dragging mechanism and the first dragging portion are contacted with each other, and the friction caused by the contact of the first dragging portion with the dragging mechanism is larger than an oblique component force opposite to the friction, so the worm gear is unrotatable around the axial rod.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a first preferable embodiment of the present invention;

FIG. 2 is a partial perspective breakdown drawing of the first preferable embodiment of the present invention;

FIGS. 3 and 4 are drawings showing a reversible monkey wrench of the first preferable embodiment of the present invention in use;

FIGS. 3A to 3D are partially-enlarged drawings of different parts of the reversible monkey wrench of the first preferable embodiment of the present invention;

FIG. 5 is a partial perspective breakdown drawing of the reversible monkey wrench of a second preferable embodiment of the present invention;

FIG. 6 is a partial cross-sectional drawing of the second preferable embodiment of the present invention;

FIG. 6A is a partially-enlarged drawing of the second preferable embodiment of the present invention;

FIG. 7 is a partial perspective breakdown drawing of the reversible monkey wrench of a third preferable embodiment of the present invention;

FIG. 8 is a partial cross-sectional drawing of the third preferable embodiment of the present invention;

FIG. 8A is a partial cross-sectional drawing of another state of the third preferable embodiment of the present invention;

FIG. 9 is a partial breakdown drawing of the reversible monkey wrench of a fourth preferable embodiment of the present invention;

FIG. 9A is a breakdown drawing of a part of components of the reversible monkey wrench of the fourth preferable embodiment of the present invention;

FIGS. 10 and 11 are drawings showing the reversible monkey wrench of the fourth embodiment of the present invention in use;

FIGS. 12 to 15 are drawings showing an opening width of a conventional reversible monkey wrench becomes larger.

### DETAILED DESCRIPTION OF THE PREFERRED EMBODIMENTS

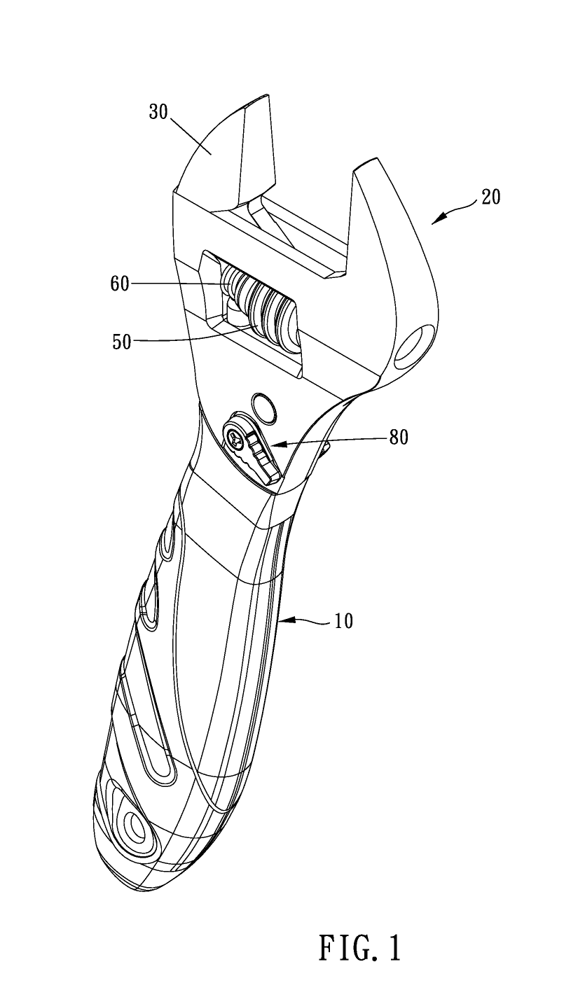

Please refer to FIGS. 1, 2, 3 and 4 for a first preferable embodiment of the present invention. A reversible monkey wrench of the present invention includes a handle 10, a head 20, a movable jaw 30, an axial rod 40, a worm gear 50 and a dragging mechanism 60.

The handle 10 is provided for operating and has a connecting end 11, and a driving head (not shown) can be arranged on the other end of the handle 10.

An end of the head 20 is formed with a fixed jaw 21, a sliding rail 22 transversely disposed, a receiving slot 23 and a connecting bore 24. The receiving slot 23 is communicated with the sliding rail 22. The connecting bore 24 is longitudinally disposed in the head 20 and communicated with the receiving slot 23 and a bottom end of the head 20. The head 20 and the connecting end 11 are swingably connected through a pivot 25. In addition, a pair of wing portions 26 extends from the bottom end of the head 20, and a slot 27 is formed between the wing portions. The connecting end 11 is disposed in the slot 27, and the pivot 25 is disposed through and pivoted to the wing portions and the connecting end 11.

A handle return spring 70, a movable pin 71 and a movable pin return spring 72 are disposed between the head 20 and the connecting end 11. The pivot 25 is positioned between the handle return spring 70 and the movable pin 71, and the handle return spring 70 is abutted between the head 20 and the connecting end 11. The movable pin 71 is disposed through the connecting bore 24, and the movable pin return spring 72 is abutted between the head 20 and the movable pin 71 and urges the movable pin 71 toward the connecting end 11. The elastic force of the handle return spring 70 is preferably larger than that of the movable pin return spring 72 so as to keep the head 20 stay naturally away from the handle return spring 70 under.

The movable jaw 30 has a sliding rod 31, and the sliding rod 31 is slidably disposed in the sliding rail 22 of the head 20. The reversible monkey wrench can use the fixed jaw 21 and the movable jaw 30 to clamp and rotate a fastener such as a nut 5.

The axial rod 40 is disposed through a transverse through bore 28 and fixedly disposed in the receiving slot 23.

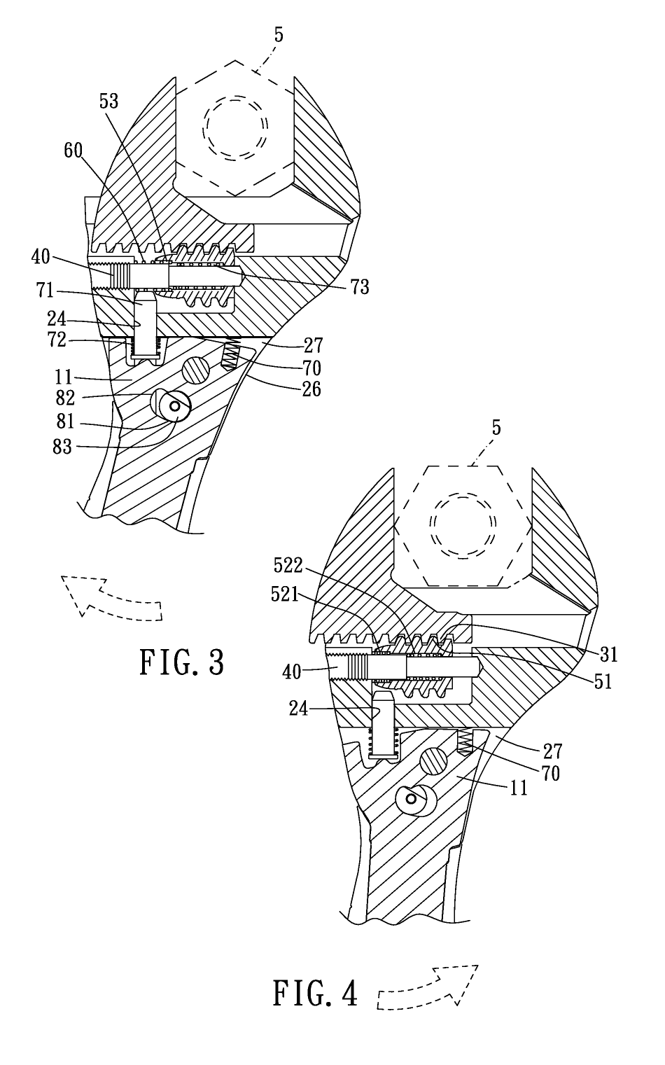

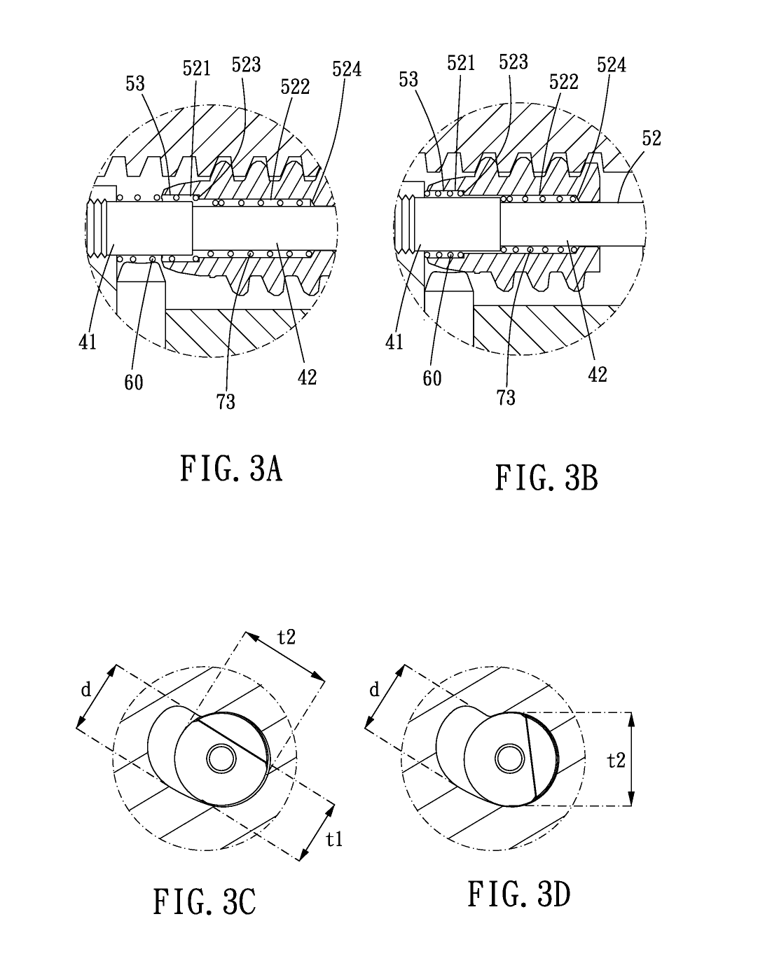

As shown in FIGS. 3A to 3D, the worm gear 50 has an engaging portion 51 corresponding to the sliding rod 31 and an axial bore 52 for the axial rod 40 to dispose therethrough. The engaging portion 51 spirally extends in south-east ( ) direction toward the fixed jaw 21. The worm gear 50 is slidably disposed in the receiving slot 23 and slidable along the axial rod 40. An end of the worm gear 50 is formed with a first dragging portion 53. More specifically, the axial bore 52 includes a wide section bore 521 facing the movable pin 71 and a narrow section bore 522 communicated with the wide section bore 521, and a shoulder portion 523 is formed on the junction of the wide section bore 521 and the narrow section bore 522. The axial rod 40 includes a large-diametered section 41 and a small-diametered section 42 extended from the large-diametered section 41. A diameter of the large-diametered section 41 is preferably (but not limited thereto) no larger than a bore diameter of the narrow section bore 522. The axial rod 40 is disposed in the axial bore 52 by inserting the small-diametered section 42 through the wide section bore 521. A worm gear return spring 73 is axially-compressible-and-reboundable and disposed between the small-diametered section 42 and the narrow section bore 522 of the worm gear 50; specifically, a worm gear return spring 73 is disposed between the large-diametered section 41 and a shoulder portion 524 at the end of the narrow section bore 522 of the worm gear 50.

The dragging mechanism 60 is disposed around the axial rod 40, and at least when the handle 10 relatively swings counter-clockwise about the pivot 25 and toward the fixed jaw 21 (that is, the handle 10 swings toward the fixed jaw 21), the dragging mechanism 60 is at least partially positioned in and overlapped with the wide section bore 521 of the worm gear 50. The dragging mechanism 60 and the wide section bore 521 of the worm gear 50 are circumferentially abutted against the first abutting portion 53. In this embodiment, the dragging mechanism 60 is uncontacted with the axial rod 40, and the dragging mechanism 60 is abutted against the first dragging portion 53 of the worm gear 50 and a part of the large-diametered section 41 of the axial rod 40; therefore, when the handle 10 relatively swings counter-clockwise about the pivot 25 and toward the fixed jaw 21, the dragging mechanism 60 can be restrained from rotating relative to the axial rod 40. In other possible embodiments, the dragging mechanism 60 is uncontacted with the worm gear 50, and preferably, the dragging mechanism 60 at least partially contacted with the large-diametered section 41 of the axial rod 40; hence, the dragging mechanism 60 can be restrained from rotating relative to the axial rod 40, and the worm gear 50 can be effectively prevented from simultaneously rotating (not shown) when the handle swings counter-clockwise toward the fixed end 21 (as shown in FIG. 4).

In this embodiment, the dragging mechanism 60 is a coil spring, and the coil spring is disposed around the axial rod 40. A first end of the coil spring is abutted against a side wall of the receiving slot 23. A second end of the coil spring is radially-compressible-and-reboundable and disposed in the wide section bore 521 of the worm gear 50, and the second end of the coil spring is radially abutted against the shoulder portion 523 of the worm gear 50 (as shown in FIG. 3B); but two ends of the coil spring can be unabutted against the side wall of the receiving slot 23 and the shoulder portion 523 as well (not shown). View from the perspective along the axis of the axial rod 40, before the coil spring is compressed, the coil spring has an outer diameter slightly larger than the wide section bore 521 of the worm gear 50. The outer diameter of the coil spring is preferably slightly larger than (or equal to) the wide section bore 521, and the coil spring and the wide section bore can be tightly engaged with each other so as to prevent the worm gear 50 from rotating. In addition, an inner diameter of the coil spring is preferably slightly larger than the large-diametered section 41 of the axial rod 40 to allow the worm gear 50 to move horizontally after the worm gear 50 is compressed.

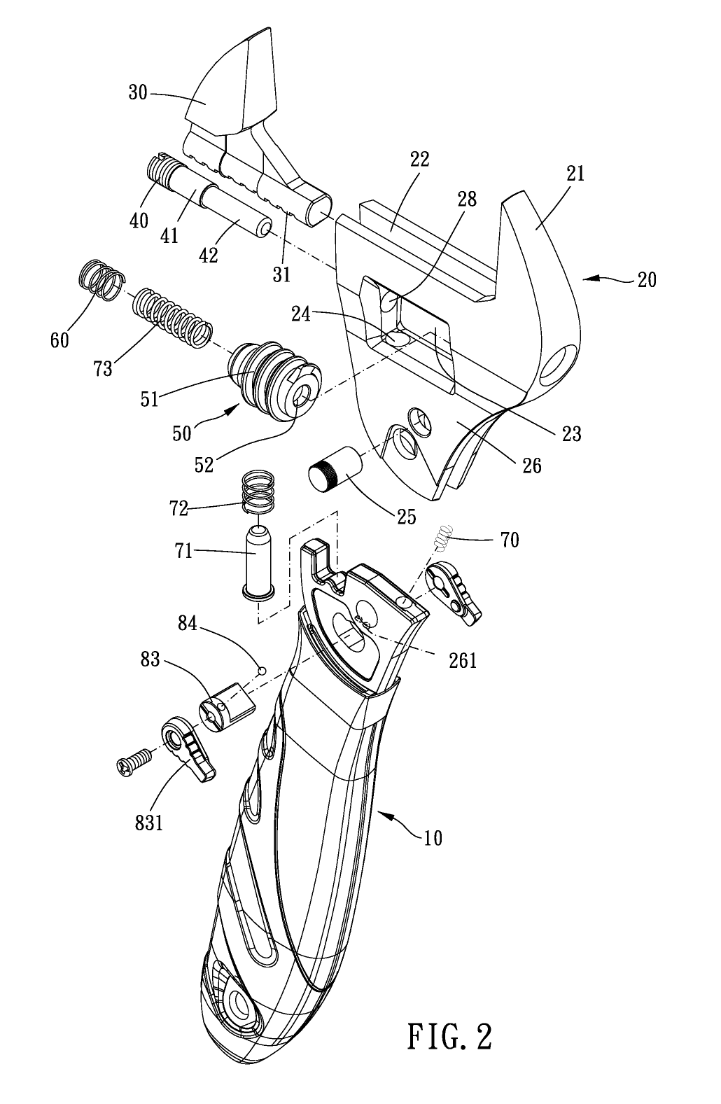

Preferably, the reversible monkey wrench further includes a locking device 80 (as shown in FIG. 1). The locking device 80 includes a receiving bore 81, an arced slot 82 and a controlling pin 83 (as shown in FIG. 3). The receiving bore 81 is disposed in either of the wing portion 26 or the connecting end, and the arced slot 82 is disposed on the other, the wing portion 26 or the connecting end 11. In this embodiment, the receiving bore 81 is disposed on the wing portion 26, and the arced slot 82 is disposed at the connecting end 11. An end of the controlling pin 83 is extended transversely and formed with a trigger portion 831. The arced slot 82 substantially takes the pivot 25 as an arc center, and a necking portion is formed between two ends of the arced slot 82. The necking portion has a smallest span d in a crossing direction across the arced slot 82. The controlling pin 83 is controllably rotatably disposed in the receiving bore 81 and the arced slot 82. The controlling pin 83 has a first radial thickness t1 and a second radial thickness t2 respectively on a first radial and a second radial which are unparallel to each other. The first radial thickness t1 is smaller than the second radial thickness t2. The first radial thickness t1 is no larger than the smallest span d of the necking portion, and the second radial thickness t2 is larger than a span of the necking portion. Preferably, the controlling pin 83 is formed with a first position limiting device 84 on the circumference, and the wing portion 26 is formed with a second position limiting device 261 which can locate the position of the first position limiting device 84, and vice versa. Specifically, the first position limiting device 84 is a protrusion, and the second position limiting device 261 is a recession; yet the first position limiting device 84 and the second position limiting device 261 (as shown in FIG. 2) can be any cooperating device which can be releasably restricted relative to a circumference (for example, a releasably elastic engaging device and a recessed bore). As shown in FIG. 3C, when the trigger portion 831 is triggered to allow the first radial of the first controlling pin 83 to be substantially parallel to the crossing direction, the necking portion allows the controlling pin 83 to pass therethrough and move in the arced slot 82; that is, the head 20 can swing relative to the connecting end 11. As shown in FIG. 3D, when the trigger portion 831 is triggered to allow the first radial of the first controlling pin 83 to be unparallel to the crossing direction, the necking portion prohibits the controlling pin to pass therethrough, so the head 20 is unswingable relative to the connecting end 11 and is locked.

In practice, when the reversible monkey wrench is turned clockwise, a top end of the movable pin 71 is abutted against a left side of the worm gear 50; therefore, the movable jaw 30 can't be moved away from the fixed jaw 21, and the nut 5 can be fixedly clamped and driven to rotate (as shown in FIG. 3).

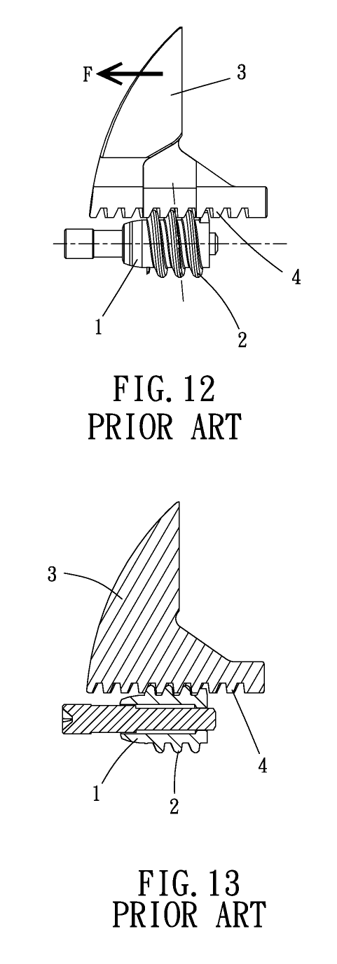

On the other hand, when the reversible monkey wrench is turned counter-clockwise, the movable pin return spring 72 will drive the movable pin 71 to radially move away from the axial rod 40; hence, the worm gear 50 is unabutted against the movable pin 71, and the handle 10 can be rotated relative to the head 20 (as shown in FIG. 4). In the meanwhile, the nut 5 will exert a horizontal force F on the movable jaw 30 (as shown in FIG. 12). When the horizontal force is larger than an elastic force of the worm gear return spring 73, the worm gear return spring 73 will be compressed, and the movable jaw 30 and the worm gear 50 will slide away from the fixed jaw 21. By carrying out the above-mentioned procedures, the reversible monkey wrench can be reciprocated.

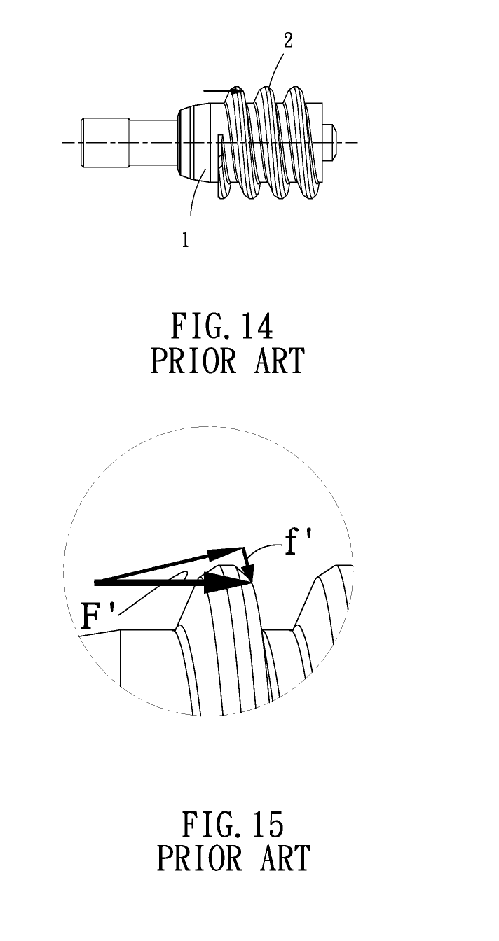

When the reversible monkey wrench is turned counter-clockwise (the direction to loosen a fastener), the sliding rod 31 of the movable jaw 30 will exert a horizontal force F on the engaging portion 51. The horizontal force F will allow the worm gear 50 to axially slide away from the fixed jaw 21. When the dragging mechanism 60 and the first dragging portion 53 are contacted with each other, and friction caused by the contact of the first dragging portion 53 with the dragging mechanism 60 is larger than an oblique component force opposite to the friction, the worm gear 50 will not rotate around the axial rod 40, wherein the component force opposite to the friction is defined to be an opposite oblique component force f′ parallel to a spiral direction ( ) of the engaging portion 51 (as shown in FIG. 15). More specifically, when the reversible monkey wrench is turned counter-clockwise, the horizontal force F exerted by the nut 5 on the movable jaw 30 will transmit to and apply on the engaging portion 51 via the sliding rod 31 so as to drive the worm gear to slide left. At the same time, the worm gear return spring 73 will produce a counter force F′ which is equal and opposite to the horizontal force F (as shown in FIG. 14). The counter force F′ will allow the engaging portion 51 of the worm gear 50 to be abutted against the sliding rod 31 having a spiral angle, and the engaging portion 51 applies an oblique force on the sliding rod 31. However, because the movable jaw 30 and the sliding rod 31 are unrotatably restricted within the sliding rail 22, the opposite oblique component force f′ will force the worm gear 50 to rotate around the axial rod 40 and rotate downward so as to make an opening gradually larger.

When the handle 10 is rotated relatively around the pivot 25 and swung toward the fixed jaw 21, the dragging mechanism 60 of the present invention is at least partially circumferentially abutted against the first dragging portion 53 of the worm gear 50; therefore, the friction caused by the contact of the dragging mechanism 60 with the worm gear 50 can be increased to counteract the oblique component force, so the worm gear 50 can be prevented from simultaneously rotating. After the reversible monkey wrench is turned back and forth many times, a gap between the movable jaw 30 and the fixed jaw 21 will not be larger; thus, the nut 5 can be fixedly clamped and driven to rotate without abrading corner verges of the nut 5.

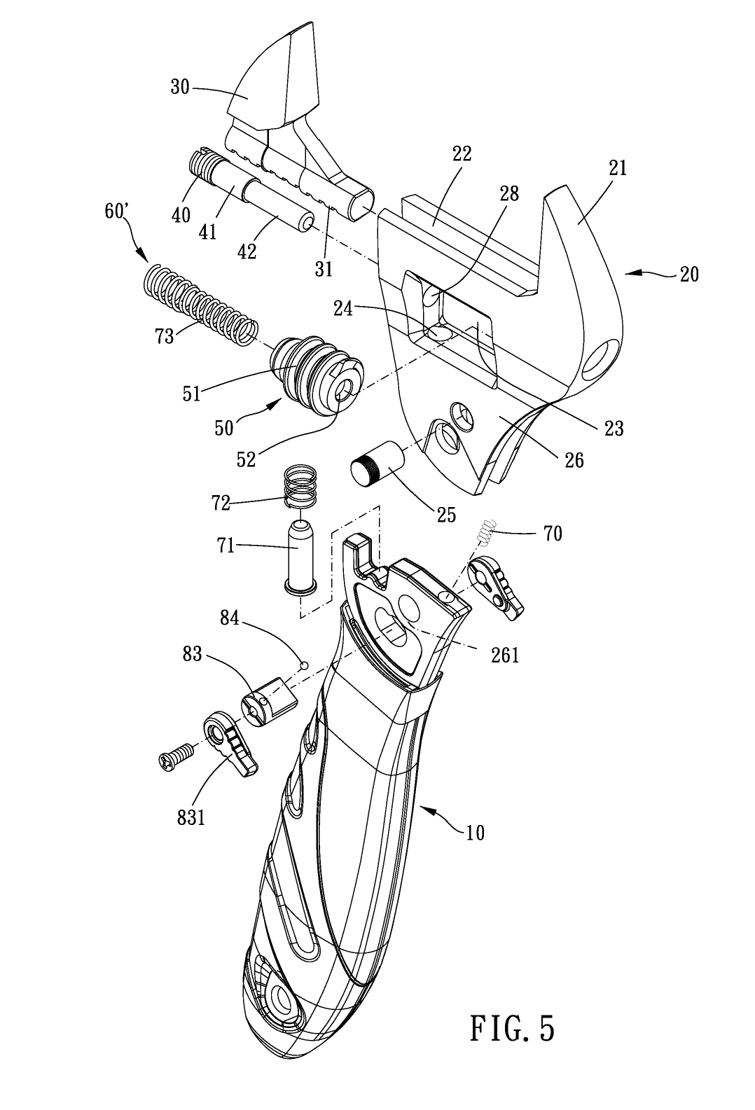

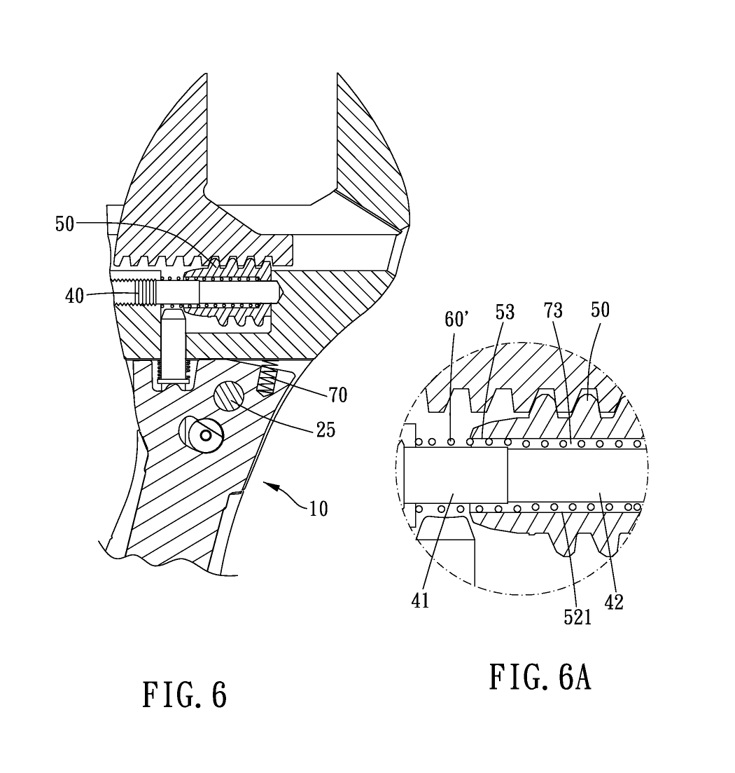

Please refer to FIGS. 5, 6 and 6A for a second preferable embodiment of the present invention. In this embodiment, a dragging mechanism 60′ (a coil spring) is integrally formed with a wide section end and a narrow section end. The narrow section end (the worm gear return spring 73) is arranged between the small-diametered section 42 of the axial rod 40 and the wide section bore 521 of the worm gear 50 (as shown in FIG. 6A). The main part of friction is provided at the wide section end (dragging mechanism 60′). The dragging mechanism 60′ can be axially integrally connected to the worm gear return spring 73 of the worm gear 50, so it is easy to assemble and time-saving. Consequently, if an area of the contacted region of the dragging mechanism 60′ and the worm gear 50 is increased, the friction will also increase. On one hand, a returning force for urging the worm gear 50 to move away from the large-diametered section 41 can be increased. On the other hand, the opposite oblique component force applied on the worm gear 50 when the handle 10 is rotated relative to the pivot 25 and swung toward the fixed jaw 21, can be restrained. In addition, after being compressed, the dragging mechanism 60′ is abutted against the side wall of the receiving slot with a larger normal force to prevent the dragging mechanism 60′ from simultaneously rotating and further to effectively prevent the worm gear 50 from simultaneously rotating.

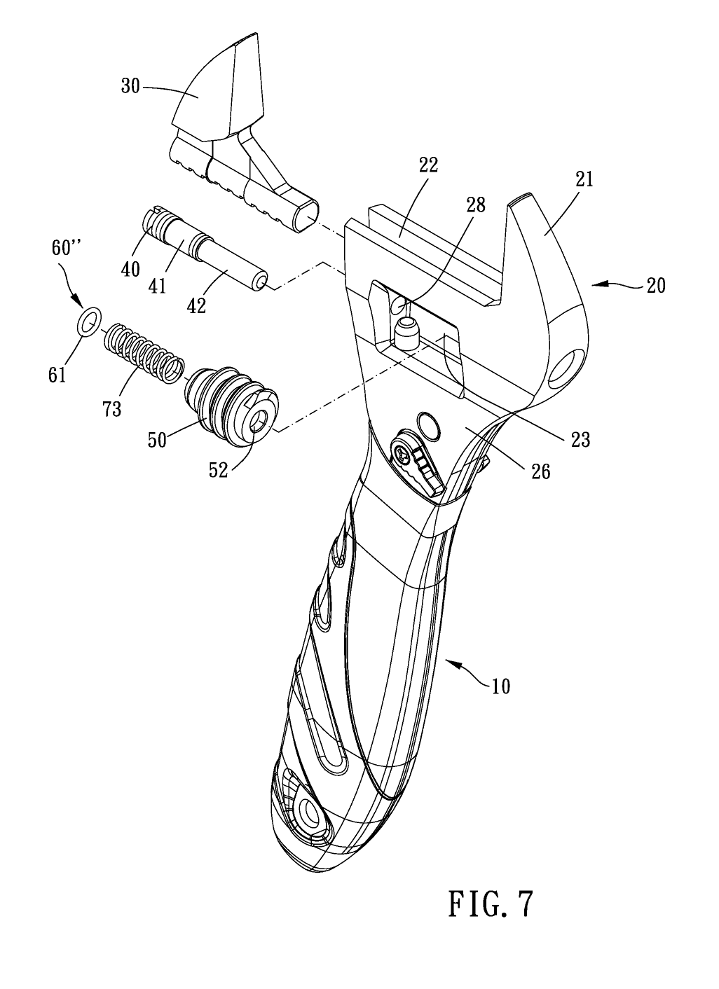

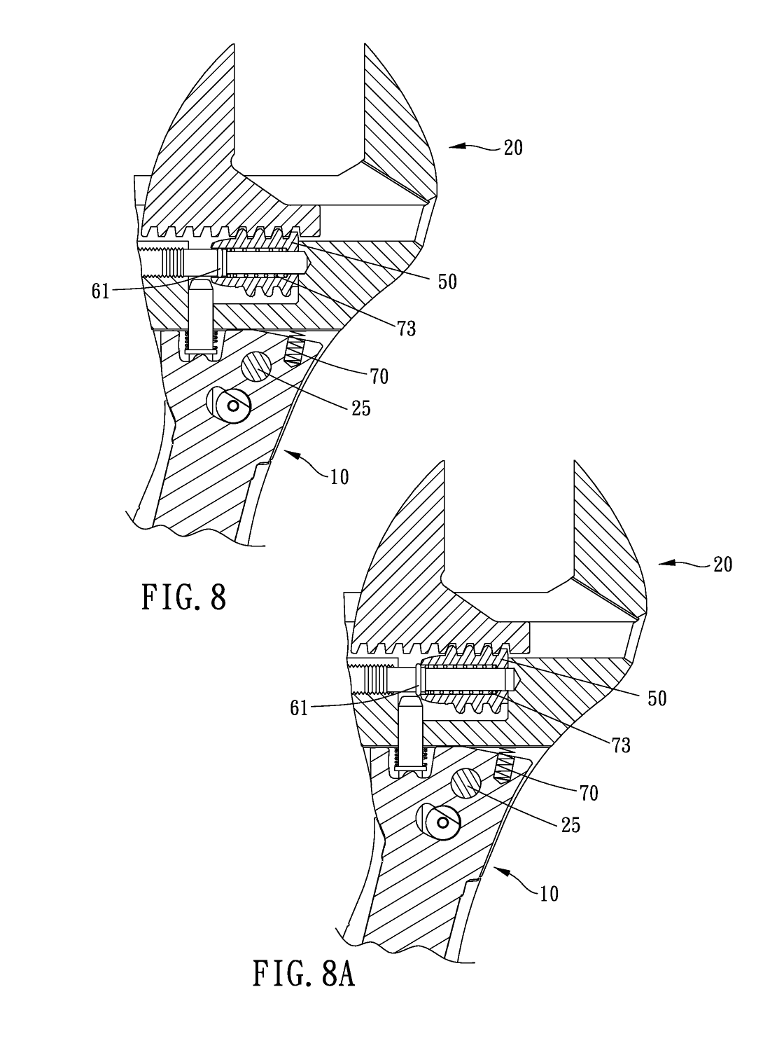

Please refer to FIGS. 7 and 8 for a third preferable embodiment of the present invention. A dragging mechanism 60″ of this embodiment includes a radially elastically deformable body 61 (It can be singular or plural. The radially elastically deformable body 61 can be made of rubber, plastic or the like.). The radially elastically deformable body 61 is substantially circumferentially extended and formed around the outer peripheral face of the axial rod 40. The radially elastically deformable body 61 is radially compressed and disposed in the wide section bore 521 of the worm gear 50 and radially abutted between the axial rod 40 and the worm gear 50. View from the perspective along the axis of the axial rod 40, before the radially elastically deformable body 61 is compressed, its outer diameter is larger than a bore diameter of the wide section bore 521 of the worm gear 50, wherein the worm gear return spring 73 is axially-compressible-and-reboundable and disposed between the small-diametered section 42 of the axial rod 40 and the worm gear 50. When the handle 10 is rotated relative to the pivot 25 and swung toward the fixed jaw 21, the worm gear 50 is uneasy to be rotated on the axis of the axial rod 40 because the radially elastically deformable body 61 is radially bounced outward and abutted against an inner face of the wide section bore 521 of the worm gear 50; therefore, the worm gear 50 can be effectively prevented from simultaneously rotating. However, in another possible embodiment, the radially elastically deformable body 61 can be disposed around the outer peripheral face of the axial rod 40 (which can be formed with a circular slot). When the handle 10 is rotated relative to the pivot 25, swung toward the fixed jaw 21 to a side of the worm gear 50 and contacted with the radially elastically deformable body 61 (as shown in FIG. 8A), the worm gear 50 will be rubbed and restrained by the radially elastically deformable body 61, so the worm gear 50 is not easy to be rotated on the axis of the axial rod 40.

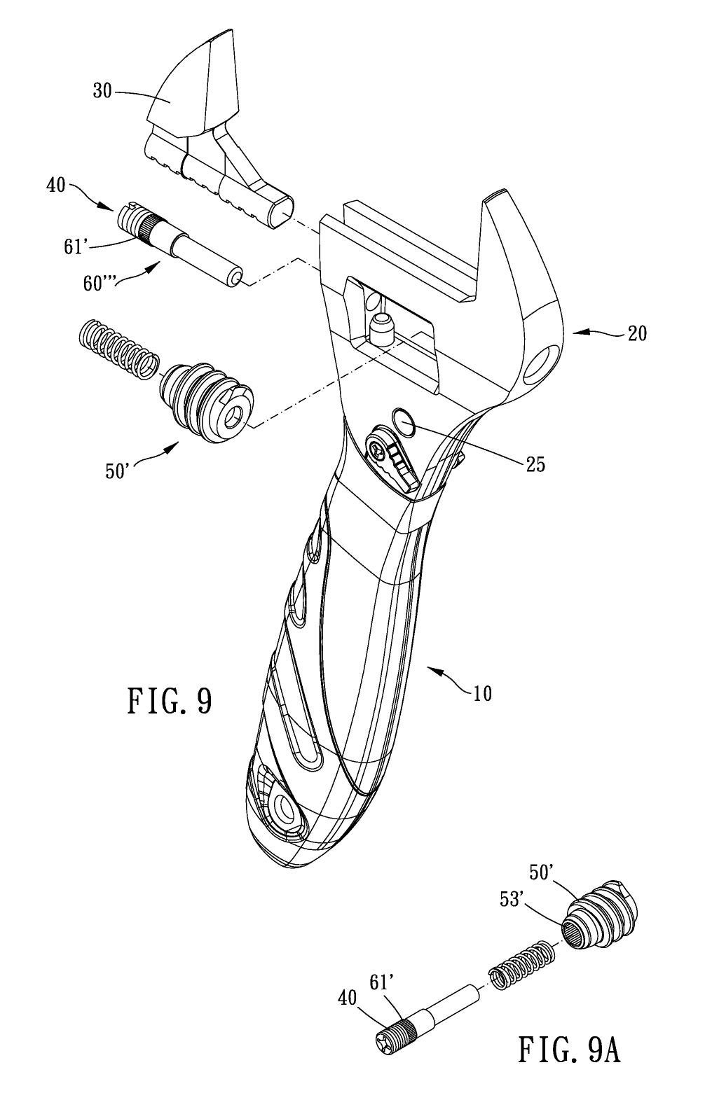

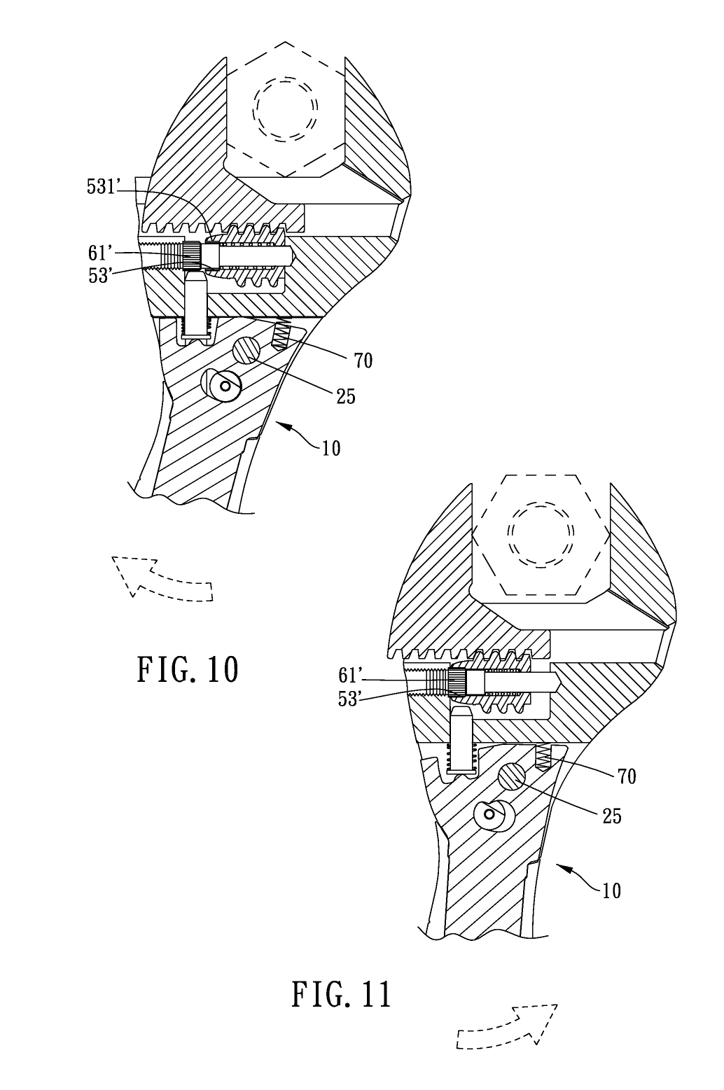

Please refer to FIGS. 9, 9A, 10 and 11 for a fourth preferable invention of the present invention. In this embodiment, a worm gear 50′ is formed with a first dragging portion 53′. The first dragging portion 53′ includes at least one first dragging device 531′. A dragging mechanism 60′″ includes at least one second resisting device 61′. More specifically, the first dragging device 531′ and the second dragging device 61′ both are toothed portions which can be meshed with each other, yet the first dragging device 531′ and the second dragging device 61′ can be any cooperating device which can be restricted relative to a circumference. (such as recessed and protruded devices). Therefore, when the worm gear 50 is rotated on the axis of the axial rod 40, the at least one first dragging device 531′ and the at least one second dragging device 61′ are abutted against each other and rotatably and restrictedly overlapped and interfered (plugged or fixedly engaged) with each other along the circumferential direction of the axial rod 40. Consequently, when the handle 10 is rotated relative to the pivot 25 and swung toward the fixed jaw 21, the worm gear 50 will not be rotated on the axis of the axial rod 40 so as to effectively prevent the worm gear from simultaneously rotating.

Give the above, through different structural arrangements of the dragging mechanism abutted against the first dragging mechanism, the worm gear can be restrained from simultaneously rotating at least when the handle is rotated relative to the pivot and swung toward the fixed jaw. The problem that the horizontal force exerted on the movable jaw will drive the worm gear to spin when the reversible monkey wrench is reciprocated can be avoided. Therefore, after many times of operations, the gap between the movable jaw and the fixed jaw will not be larger.

In addition, the dragging mechanism can be axially abutted against the worm gear or integrally, axially overlappedly or abuttedly connected to the worm gear return spring of the worm gear so as to increase the friction between the dragging mechanism and the worm gear and elevate the effect of preventing the worm gear from simultaneously rotating.

Furthermore, the dragging mechanism can be made of radially compressible elastic materials, which have great effect of preventing the worm gear from simultaneously rotating. This kind of dragging mechanism has a simple structure, so it is easy to be assembled and cheap to be manufactured.

What is claimed is:

1. A reversible monkey wrench, including:
a handle;
a head, formed with a fixed jaw, a sliding rail, a receiving slot at an end;
a movable jaw, having a sliding rod slidably disposed in the sliding rail of the head;
an axial rod, disposed in the head and extended into the receiving slot;
a worm gear, having an engaging portion corresponding to the sliding rod and an axial bore for the axial rod to dispose therethrough, the worm gear slidably disposed in the receiving slot and slidable along the axial rod, an end of the worm gear formed with a first dragging portion; and
a dragging mechanism, disposed around the axial rod and circumferentially contacted with the first dragging portion;
wherein when the worm gear is slided axially, the dragging mechanism and the first dragging portion will be contacted with each other; friction caused by the contact of the first dragging portion with the dragging mechanism is larger than an oblique component force opposite to the friction, so when the worm gear is slided axially, the worm gear is unrotatable around the axial rod; and the oblique component force is defined as a component force parallel to a spiral direction of the engaging portion.

2. A reversible monkey wrench, including:
a handle, having a connecting end;
a head, formed with a fixed jaw, a sliding rail, a receiving slot and a connecting bore at an end, the receiving slot communicated with the sliding rail, a bottom end of the head swingably connected with the connecting end through a pivot; a handle return spring, a movable pin and a movable pin return spring disposed between the head and the connecting end; the pivot positioned between the handle return spring and the movable pin; the handle return spring abutted between the head and the connecting end; the movable pin disposed through the connecting bore; the movable pin return spring abutted between the head and the movable pin and urging the movable pin toward the connecting end;
a movable jaw, having a sliding rod, the sliding rod slidably disposed in the sliding rail of the head;
an axial rod, disposed in the head and extended into the receiving slot;
a worm gear, having an engaging portion corresponding to the sliding rod and an axial bore for the axial rod to dispose therethrough, the engaging portion spirally extended toward the fixed jaw, the worm gear slidably disposed in the receiving slot and slidable along the axial rod, an end of the worm gear formed with a first dragging portion; and
a dragging mechanism, disposed around the axial rod and circumferentially engaged and contacted with the first dragging portion;
wherein when the worm gear is slided axially, the dragging mechanism and the first dragging portion will be contacted with each other; friction caused by the contact of the first dragging portion with the dragging mechanism is larger than an oblique component force opposite to the friction, so the worm gear is unrotatable around the axial rod.

3. The reversible monkey wrench of claim 1, wherein the dragging mechanism is a coil spring, the coil spring is disposed around the axial rod, a first end of the coil spring is abutted against a side wall of the receiving slot, a second end of the coil spring is radially compressed and disposed in the axial bore and radially abutted against the worm gear, and viewed from the perspective along the axis of the axial rod, before the second end of the coil spring is compressed, it has an outer diameter larger than a bore diameter of the axial bore.

4. The reversible monkey wrench of claim 1, wherein at least when the handle is swung relatively around the axial rod toward the fixed jaw, the dragging mechanism is abutted against the first dragging portion of the worm gear, but the dragging mechanism is uncontacted with the axial rod.

5. The reversible monkey wrench of claim 1, wherein the axial bore includes a wide section bore facing the movable pin and a narrow section bore communicated with the wide section bore, a shoulder portion is formed on the junction of the wide section bore and the narrow section bore, the axial rod includes a large-diametered section and a small-diametered section extended from the large-diametered section, the diameter of the large-diametered section is no larger than the bore diameter of the narrow section bore, the axial rod is disposed in the axial bore by inserting the small-diametered section through the wide section bore, and two ends of the dragging mechanism are respectively abutted against the side wall and the shoulder portion within the receiving slot.

6. The reversible monkey wrench of claim 5, wherein a worm gear return spring is radially compressed and elastically disposed between the small-diametered section of the axial rod and the narrow section bore of the worm gear.

7. The reversible monkey wrench of claim 1, wherein a part of the dragging mechanism which is uncontacted with the worm gear is at least partially contacted with the axial rod.

8. The reversible monkey wrench of claim 1, wherein the dragging mechanism includes at least one radially elastically deformable body, the at least one radially elastically deformable body is substantially circumferentially extended and disposed around the outer peripheral face of the axial rod, the at least one radially elastically deformable body is radially compressed to be disposed in the axial bore and radially abutted between the axial rod and the worm gear; viewed from the perspective along the axis of the axial rod, before the at least one radially elastically deformable body is compressed, it has an outer diameter larger than the bore diameter of the axial bore, and a worm gear return spring is axially-compressible-and-reboundable and disposed between the large-diametered section and the worm gear.

9. The reversible monkey wrench of claim 8, wherein the axial rod includes a large-diametered section and a small-diametered section extended from the large-diametered section, the axial rod is disposed in the axial bore via the small-diametered section, and at least one radially elastically deformable body is substantially circumferentially extended and disposed around the outer peripheral face of the large-diametered section.

10. The reversible monkey wrench of claim 1, wherein the first dragging portion includes at least one first resisting structure, the dragging mechanism includes at least one second resisting structure; when the at least one first resisting structure and the at least one second resisting structure are unengaged with each other, the worm gear is rotatable around the axial rod; when the at least one first resisting structure and the at least one second resisting structure are engaged with each other, the worm gear is restricted and unable to rotate.

11. The reversible monkey wrench of claim 2, wherein the dragging mechanism is a coil spring, the coil spring is disposed around the axial rod, a first end of the coil spring is abutted against a side wall of the receiving slot, a second end of the coil spring is radially compressed and disposed in the axial bore and radially abutted against the worm gear, and viewed from the perspective along the axis of the axial rod, before the second end of the coil spring is compressed, it has an outer diameter larger than a bore diameter of the axial bore.

12. The reversible monkey wrench of claim 2, wherein at least when the handle is swung relatively around the axial rod toward the fixed jaw, the dragging mechanism is abutted against the first dragging portion of the worm gear, but the dragging mechanism is uncontacted with the axial rod.

13. The reversible monkey wrench of claim 2, wherein the axial bore includes a wide section bore facing the movable pin and a narrow section bore communicated with the wide section bore, a shoulder portion is formed on the junction of the wide section bore and the narrow section bore, the axial rod includes a large-diametered section and a small-diametered section extended from the large-diametered section, the diameter of the large-diametered section is no larger than the bore diameter of the narrow section bore, the axial rod is disposed in the axial bore by inserting the small-diametered section through the wide section bore, and two ends of the dragging mechanism are respectively abutted against the side wall and the shoulder portion within the receiving slot.

14. The reversible monkey wrench of claim 13, wherein a worm gear return spring is radially compressed and elastically disposed between the small-diametered section of the axial rod and the narrow section bore of the worm gear.

15. The reversible monkey wrench of claim 2, wherein a part of the dragging mechanism which is uncontacted with the worm gear is at least partially contacted with the axial rod.

16. The reversible monkey wrench of claim 2, wherein the dragging mechanism includes at least one radially elastically deformable body, the at least one radially elastically deformable body is substantially circumferentially extended and disposed around the outer peripheral face of the axial rod, the at least one radially elastically deformable body is radially compressed to be disposed in the axial bore and radially abutted between the axial rod and the worm gear; viewed from the perspective along the axis of the axial rod, before the at least one radially elastically deformable body is compressed, it has an outer diameter larger than the bore diameter of the axial bore, and a worm gear return spring is axially-compressible-and-reboundable and disposed between the large-diametered section and the worm gear.

17. The reversible monkey wrench of claim 16, wherein the axial rod includes a large-diametered section and a small-diametered section extended from the large-diametered section, the axial rod is disposed in the axial bore via the small-diametered section, and at least one radially elastically deformable body is substantially circumferentially extended and disposed around the outer peripheral face of the large-diametered section.

18. The reversible monkey wrench of claim 2, wherein the first dragging portion includes at least one first resisting structure, the dragging mechanism includes at least one second resisting structure; when the at least one first resisting structure and the at least one second resisting structure are unengaged with each other, the worm gear is rotatable around the axial rod; when the at least one first resisting structure and the at least one second resisting structure are engaged with each other, the worm gear is restricted and unable to rotate.
